(19) United States
(12) Patent Application Publication
(10) Pub. No.: US 2015/0120652 A1
(43) Pub. Date: Apr. 30, 2015

(54) REPLICATED DATA STORAGE SYSTEM AND METHODS

(71) Applicants: Jens Dittrich, Saarbrucken (DE); Jorge-Arnulfo Quiané-Ruiz, Saarbrucken (DE); Stefan Richter, Saarbrucken (DE); Stefan Schuh, Saarbrucken (DE); Alekh Jindal, Saarbrucken (DE); Jörg Schad, Saarbrucken (DE)

(72) Inventors: Jens Dittrich, Saarbrucken (DE); Jorge-Arnulfo Quiané-Ruiz, Saarbrucken (DE); Stefan Richter, Saarbrucken (DE); Stefan Schuh, Saarbrucken (DE); Alekh Jindal, Saarbrucken (DE); Jörg Schad, Saarbrucken (DE)

(21) Appl. No.: 14/385,168

(22) PCT Filed: Mar. 20, 2012
(86) PCT No.: PCT/EP2012/054920

§ 371 Date: Nov. 4, 2014

(51) Int. Cl. G06F 17/30

(52) U.S. Cl. CPC G06F 17/30584; G06F 17/30598; G06F 17/30312; G06F 17/30477
USPC 707/610

(57) ABSTRACT

A method for storing data in a replicated data storage system according to the invention comprises the steps of: partitioning the data into data blocks; and storing multiple replicas of a data block in a machine readable medium.

The present invention relates to a replicated data storage system.

### TECHNICAL BACKGROUND AND PRIOR ART

Software frameworks such as Apache Hadoop or MapReduce support data-intensive distributed applications, enabling them to work with thousands of nodes and petabytes of data.

When analyzing a large web log, for example, the web log may contain different fields like ‘visitDate’, ‘adRevenue’ and ‘sourceIP’ that may serve as filter conditions. In the existing HDFS and Hadoop MapReduce stack, this log file may be uploaded to HDFS using the HDFS client. HDFS then partitions the file into logical blocks using a constant block size (the HDFS default is 64 MB). Each block is then physically stored three times (assuming the default replication factor of three). Each physical copy of a block is called a replica. Each replica will sit on a different data node. Therefore, at least two node failures may be tolerated by HDFS. Information on the different replicas for an HDFS block is kept in a central name node directory.

After uploading his log file to HDFS, one may run an actual Map Reduce job. Assuming a user is interested in all source IPs with a visit date from 2011, a map-only MapReduce program may be written to filter out exactly those records and discard all others. Hadoop MapReduce is invoked through a Hadoop MapReduce JobClient which sends a MapReduce job to a central node termed JobTracker. The JobTracker then breaks the MapReduce job into tasks. A task is executed on a subset of the input file, typically an HDFS block. The JobTracker assigns each task to a different TaskTracker which typically runs on the same machine as the HDFS data node. Each data node will then read its subset of the input file, i.e. a set of HDFS blocks, and feed that data into the MapReduce processing pipeline which usually consists of a Map, Shuffle, and a Reduce Phase. As soon as all results have been written to HDFS, the user is informed that the result sets are available.

The execution time of the MapReduce job is strongly influenced by the size of the initial input because Hadoop MapReduce reads the input file(s) entirely for each MapReduce job. When a user is interested in exploring data, using a sequence of different filter conditions, each one triggering a new MapReduce job, this may become a major impediment.

More particularly, the time to execute a Hadoop MapReduce job based on a scan may be very high: it is dominated by the I/O for reading all input data. Every time the user modifies the MapReduce job, the same time penalty is incurred.

Also, index creation is expensive. The time to create an index on an attribute is very long, much longer than running a scan-based query on all data in the first place. If the index is only used a few times, the index creation costs will never be amortized. Third, it is not clear which attribute to index. Even if the user amortizes index creation costs by running two dozen queries filtering data on the attribute sourceIP′, the index will only help for that particular attribute. However, the index will not help when searching for other attributes.

Further, if a dataset contains lot more attributes than the number of replicas or if a large number of analytical queries are used, it is desirable to select just the right indexes instead of generating all indexes indiscriminately. However, current index selection algorithms do not take into account default data replication, which happens in Hadoop MapReduce. Therefore, these algorithms do not aim at producing, possibly, different indexes for each replica. Second, existing algorithms have to consider a large search space of candidate covering indexes, even though the covering attributes may not be co-accessed in the same horizontal ranges.

It is therefore an object of the present invention to provide a replicated data storage system and methods for storing and retrieving data that with faster execution times. It is a further object of the invention to provide a replicated data storage system and methods for storing and retrieving data with a reduced overhead for index creation. Finally, it is also an object of the present invention to provide an efficient method for index selection in a replicated data storage system.

### SUMMARY OF THE INVENTION

This object is achieved by the methods for storing and retrieving data and the system according to the independent claims. Advantageous embodiments are defined in the dependent claims.

More particularly, a method for storing data according to the invention comprises the steps of partitioning the data into data blocks; and storing multiple replicas of a data block in a machine readable medium.

According to one embodiment of the invention, the multiple replicas of a data block may comprise different layouts. The different layouts may be created based on a workload of the data management system. The different layouts may comprise different orderings of attributes. The attributes may be grouped based on an attribute usage of the query workload. The grouping of attributes may further be based on a relative importance of attribute pairs in terms of the query workload cost. The grouping may further be based on a mutual information between attributes. Finally, the columns may be grouped by solving a 0-1-Knapsack problem.

According to another embodiment of the invention, the replicas of each data block may comprise different sort orders. In addition, the replicas of a data block may be stored together with different indexes. The indexes may be clustered indexes. They may be created while uploading the data to a system for managing it.

The invention also comprises a method for executing a query to a data management system, wherein the data is partitioned into data blocks, wherein a data block is stored in different replicas, wherein the method comprises the steps of receiving the query; selecting a data block replica, based on the query and the physical layout; and routing sub-queries to the data node storing the selected data block replica. The data management system may be a map-reduce-system. The query may be adapted automatically. The selected data block replica may be the replica having minimal access time, according to a cost model. Alternatively, the selected data block replica may be the replica having second best access time.

The above-described independent aspects of the invention, namely the different layouts, sort orders and indexes per replica may be combined in a single system for replicated data storage. An automatic index selection method suitable for this embodiment of the invention may automatically select, generate and store different indexes for each replica. In order to prune the search space for candidate covering indexes, the automatic index selection method may simultaneously consider the vertical partitioning, i.e. whether covering attributes are co-accessed in the same horizontal ranges.

Finally, the invention also comprises a system for storing data, the system having means for partitioning the data into data blocks; data nodes for storing multiple replicas of each data block in a machine readable medium; and a name node, wherein the name node maintains a pointer to a layout descriptor of a data block replica.

The system and methods of the invention often improve both upload and query times, even though the input file is converted into PAX, a series of different sort orders is created, together with multiple clustered indexes. The user does not experience a significant delay when uploading data. Most importantly, query runtimes will improve in many cases.

In order to avoid high costs at upload time, an implementation of the inventive method may advantageously exploit the unused CPU ticks which are not used by standard HDFS. As the standard HDFS upload pipeline is I/O-bound, the effort for sorting and index creation in the inventive upload pipeline is hardly noticeable. In addition, as data is already parsed to binary form while uploading, one may often benefit from a smaller binary representation triggering less network and disk I/O.

In the case the methods according to the invention are implemented as an extension to an existing data management system, such as HDFS and Hadoop MapReduce, the fail-over properties of the existing data processing system are not affected. All data stays on the same logical HDFS block. Just the physical representation of each replica of an HDFS block is changed. Therefore from each replica one may recover the logical HDFS block.

### BRIEF DESCRIPTION OF THE FIGURES

These and other advantages and aspects of the present invention will be described more thoroughly in the following detailed description of different embodiments of the invention, in connection with the figures, in which

FIG. 1 shows a schematic overview of an upload pipeline according to a first embodiment to the invention;

FIG. 2 shows a data column index according to the first embodiment of the invention and

FIG. 3 shows a schematic overview of a query processing pipeline according to the first embodiment of the invention.

FIG. 4 shows an example of a per-replica layout according to a second embodiment of the invention;

FIG. 5 shows—in pseudo-code—algorithms 1, 2 and 3 for creating per-replica layouts according to the second embodiment of the invention;

FIG. 6 shows quadruplets for a data block stored at a name node according to the second embodiment of the invention;

FIG. 7 is a schematic overview of a method for storing data according to the second embodiment of the invention;

FIG. 8 shows—in pseudo-code—an algorithm for automatically reconstructing data tuples in a query processing method according to the second embodiment invention;

FIG. 9 shows examples of a query set and a usage matrix determined according to this modified approach.

FIG. 10 shows diagrams a, b and c with data on the performance of the inventive system as compared to the standard Hadoop MapReduce and the Hadoop++ system

### DETAILED DESCRIPTION OF THE INVENTION

Without limitation, the invention may be implemented as an extension to the existing Hadoop database system, described in the book “Hadoop. The Definitive Guide” by Tom White (2^{nd} edition September 2010, O'Reilly Media).

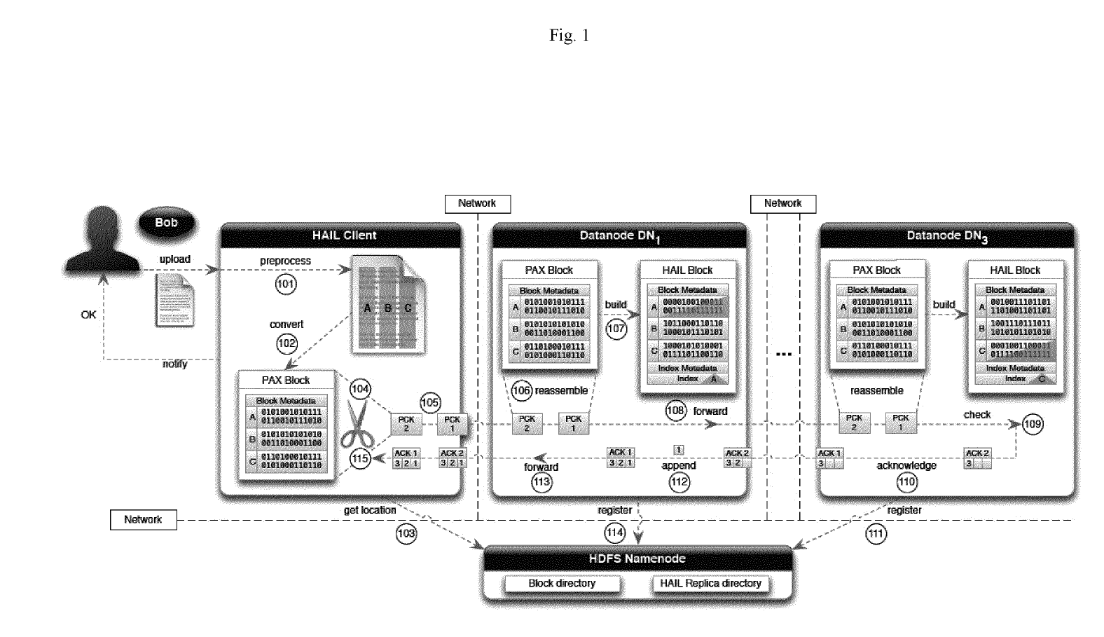

FIG. 1 shows a schematic overview of an upload pipeline according to a first embodiment to the invention.

A user uploads a data file, e.g. a log file, to the inventive data management system, using client software.

In step 101, the client software pre-processes the file based on its content. The contents are parsed into rows by searching for end of line symbols. Only entire rows are then kept on a block. This is in contrast to standard HDFS which splits a file into HDFS blocks after a constant number of bytes. For each block the client parses each row according to the schema specified by the user in step 103. All data blocks are then converted to a binary PAX representation in step 102. In addition, some metadata information may be collected from each data block, such as the data schema, and used to create a block header comprising block metadata for each data block.

In step 103, the client gets a list of data nodes to use for this block from the HDFS name node.

In order to reuse as much of the existing HDFS pipeline and yet to make the inventive method efficient, the client software creates the PAX block, cuts it into packets in step 104 and sends it to data node DN1 in step 105. Whenever a data node DN1-DN3 receives a packet, it does neither flush its data nor its checksums to disk. DN1 and DN2 immediately forward the packet to the next data node DN3 in step 108. DN3 will re-compute the checksum based on the chunks for the received PAX block in step 109 and acknowledge the packet back to DN2 in step 110. Compared to the HDFS pipeline according to the prior art, this means that the semantics of an ACK for a packet of a block are changed from “packet received, validated, and flushed” to “packet received and validated”.

Neither the chunks nor its checksums are flushed to disk as the entire block will first be sorted according to the desired sort key.

Instead, all packets are reassembled in main memory in step 106. This is a reasonable assumption for most modern servers, as main memories tend to be beyond 10 GB for any modern server. The HDFS block size is limited to 1 GB, typically it is much smaller (the HDFS default is 64 MB). This means that about 150 blocks may be kept in main memory at the same time.

In parallel to forwarding and reassembling packets, each data node sorts the data and creates indexes in step 107. As part of this process, datanodes may also add index metadata information to each data block in order to specify the indexes they created for these blocks. A datanode, e.g. DN₁, typically sorts the data in a different sort order, with respect to other datanodes, in order to create a different clustered index. Different sort orders across replicas does not impact on the fault-tolerance, as all the data is still preserved in case a datanode fails. As soon as a data node has completed sorting and creating its index, it will re-compute checksums for each chunk of a block. Checksums will differ on each replica, as different sort orders and indexes are used. Hence each data node has to compute its own checksums.

Then each data node flushes the chunks and newly computed checksums to two separate files on local disk as before. For DN3, once all chunks and checksums have been flushed to disk, DN3 will acknowledge the last packet of the block back to DN2 in step 110. After that DN3 will inform the HDFS name node about its new replica including its block size, the created indexes, and the sort order in step 111. Data nodes DN2 and DN1 append their ID to each ACK in step 112. Then they forward each ACK back in the chain in step 113. DN2 and DN1 will forward the last ACK of the block only when all chunks and checksums have been flushed to their disk. After that DN2 and DN1 also individually inform the HDFS name node in step 114.

In HDFS, the central name node keeps a directory Dir_block of blocks, i.e. a mapping from a block ID (blockID) to the set of data nodes. This directory is required by any operation retrieving blocks from HDFS. Hadoop MapReduce exploits Dir_block for scheduling. In Hadoop MapReduce whenever a block needs to be assigned to a worker in the map phase, the scheduler looks up Dir_block in the HDFS name node to retrieve the list of data nodes having a replica of that block. Then the Hadoop MapReduce scheduler will try to schedule map tasks on those data nodes if possible. Unfortunately, the HDFS name node does not differentiate the replicas any further with respect to their physical layouts. HDFS was simply not designed for this. From the point of view of the name node all replicas are byte equivalent and have the same size.

The invention allows Hadoop MapReduce to change the scheduling process to schedule map tasks close to replicas having a suitable index—otherwise Hadoop MapReduce would pick indexes randomly. Hence the HDFS name node is extended to keep additional information about the available indexes by keeping an additional directory Dir_rep mapping (blockID, data node)→HAILBlockReplicaInfo. An instance of HAILBlock ReplicaInfo contains detailed information about the types of available indexes for a replica, i.e. indexing key, index type, size, start offsets, and so on.

The extra directory Dir_rep may be implemented as a main memory HashMap. As before Hadoop MapReduce looks up Dir_block to retrieve the list of data nodes having a replica for this block. In addition, with that result list the modified Hadoop MapReduce looks up the main memory Dir_rep to obtain the detailed HAILBlockReplicaInfo for each replica, i.e. one main memory lookup for each replica. That information is then exploited to change the scheduling strategy of Hadoop MapReduce.

According to the invention, different indexes may be created for different replicas.

Preferably, the created indexes are clustered indexes. The invention requires an index structure that is cheap to create in main memory, cheap to write to disk, and cheap to query from disk. Compared to coarse-granular indexes and un-clustered indexes, the inventors discovered after some experimentation that sorting and index creation in main memory is so fast that techniques like partial or coarse-granular sorting do not pay off for the inventive system and methods.

An example of coarse-granular sorting and indexing would be to not sort data inside each 4 KB block of a leaf page. At query time, one would then have to post-filter all records contained in the first and last of the qualifying leaves; and not only the beginning and the end of those leaves. In contrast, the inventive system and method will only post-filter the first leaf until the first qualifying record is found.

Three or two seconds for sorting and indexing per block during upload are hardly noticeable in the overall upload process of HDFS. In addition, a major problem with un-clustered indexes is that they are only competitive for very selective queries as they may trigger considerable random I/O for nonselective index traversals. In contrast, clustered indexes do not have that problem. Whatever the selectivity, the system will read the clustered index and scan the qualifying blocks. Hence, even for very low selectivities the only overhead over a scan is the initial index node traversal—which is very cheap in comparison to the scan and especially in comparison to an un-clustered index traversal. Moreover, as un-clustered indexes are dense by definition, they require considerably more space on disk and require more write I/O than a sparse clustered index. This would severely affect upload times.

The inventive system may also be further extended to support additional indexes which might boost the performance of our system even further including bitmap indexes for low cardinality domains or inverted lists for un-typed or bad records, i.e. records not obeying a specific schema.

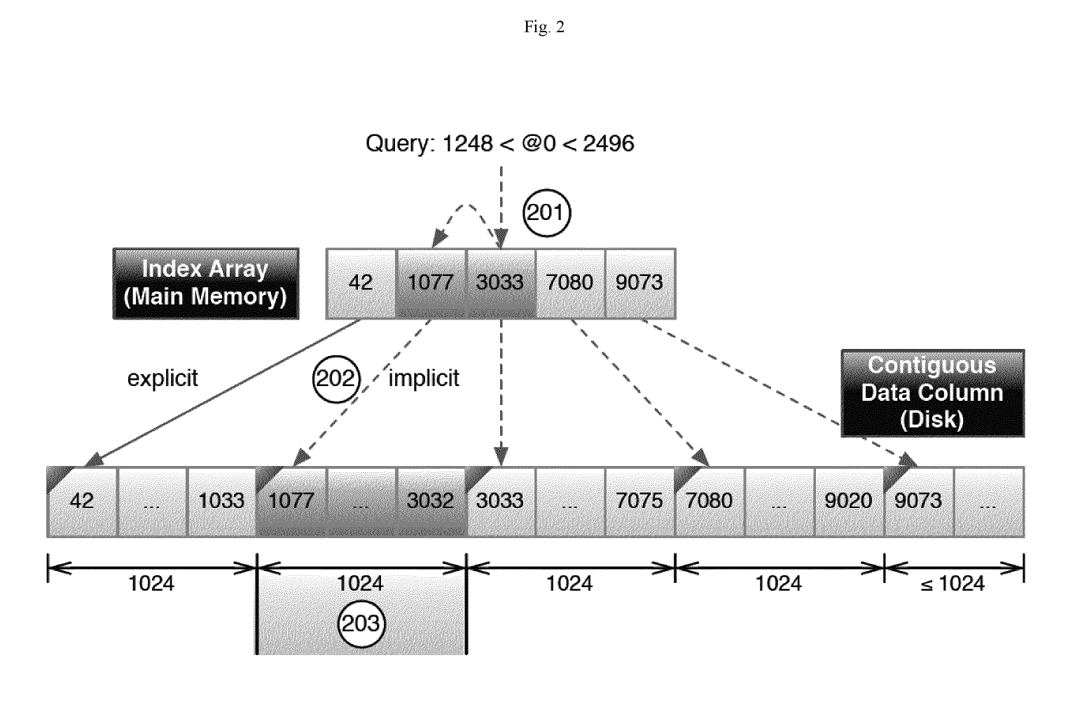

FIG. 2 shows a data column index according to the first embodiment of the invention.

All sorting and index creation happens in main memory; this assumption is realistic as the HDFS block size is small, i.e. 64 MB up to 1 GB. Hence, on each data node several blocks may be indexed in parallel entirely in main memory. Assuming one wants to create a clustered index on the attribute sourceIP′, the data is first sorted using ‘sourceIP’ as the sort key. The sort order must be preserved among all columns in the PAX-block. Therefore, a sort index is built to reorganize all other columns as explained above. After that a sparse clustered CSB+-tree is created which has a single large root directory. It logically divides the data of attribute sourceIP′ into partitions consisting of 1024 values and has child pointers to their start offsets (see FIG. 2). All but the first child pointer are implicitly defined as all leaves are contiguous on disk and can be reached by simply multiplying the leaf size with the leaf ID. The structure has some similarities with a CSB+-tree, however the inventive index is different in that all leaves are kept contiguous on disk rather than in main memory. In addition, a single directory is kept since index lookups are dominated by disk seeks.

Only for HDFS blocks larger than 5 GB, a multi-level index would pay off. However, HDFS currently supports only up to 1 GB block sizes. In contrast to a standard B+-tree range query the first and the last partition 201 and 202 of the data to read in main memory may be determined in order to avoid post-filtering the entire range 203.

Accessing variable-size attributes is different from accessing fixed-size attributes like ‘sourceIP’ in that one cannot simply calculate the offsets of partitions anymore. In general, variable-sized attributes are stored as a sequence of zero-terminated values. Whenever a block is indexed, additional lists of offsets are also created for all variable-size attributes and stored in front of their corresponding data. Only one offset for each logical partition needs to be stored. Hence only every n-th offset is stored, where n is the number of values in each partition.

With this minor modification the index according to the invention supports tuple reconstruction for variable-size attributes. For instance, assuming a query filtering on fixed-size attribute sourceIP′ and projecting to a variable-length attribute ‘URL’, the index on the attribute sourceIP′ returns a number of qualifying row IDs. For these row IDs one has to retrieve their variable-length ‘URL’ attribute values. This may be achieved by looking up the offsets to the next partition in main memory. Assuming one needs to retrieve the ‘URL’ values for row ID=43, 425 and each partition has 201, 024 entries. Then, the partitions └43, 425/1, 024┘=42 are scanned entirely from disk. The overheads for scanning that partition over the initial random I/O are small. Then, in main memory the partition is post-filtered to retrieve the URL for row ID 43, 425.

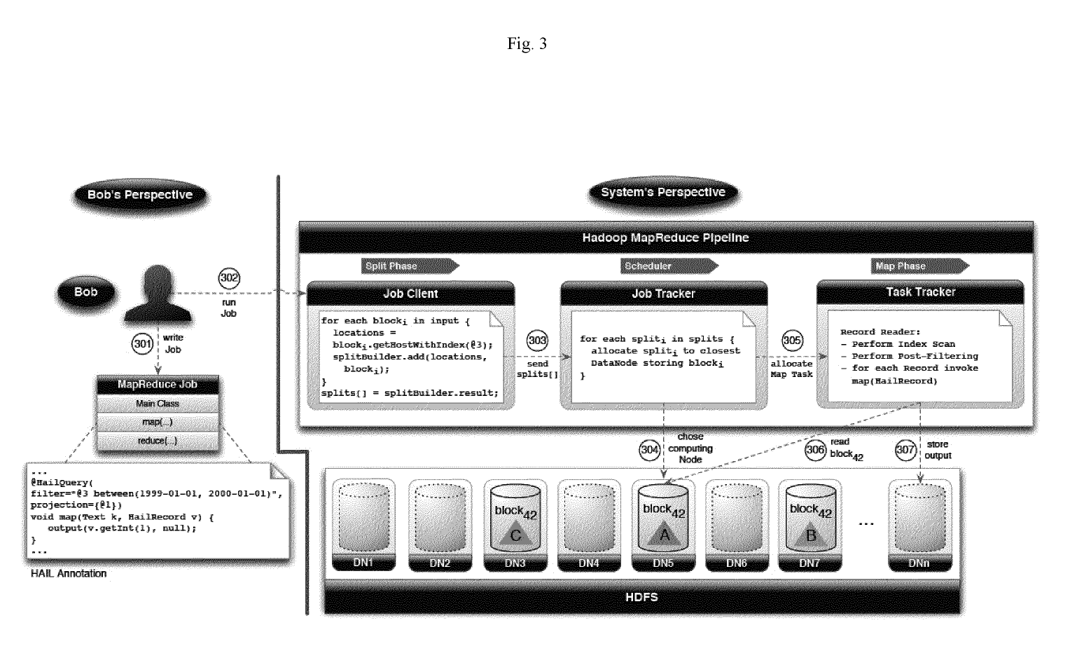

FIG. 3 shows a schematic overview of a query processing pipeline according to the first embodiment of the invention.

In step 301, the user writes a main class (job setup), a map function, and a reduce function to build a MapReduce job. He may annotate the map function to specify the selection predicate as well as the projected attributes required by his MapReduce job. In case the user does not specify filter predicates, the inventive method for querying a data management system will perform a full scan on the data blocks. At query processing time, if the query annotation is set, the system then checks, using the Index Metadata of a data block, whether an index exists on the attribute of the filter parameter. Using such an index allows for speeding up the execution of a map task. The inventive system also uses the Block Metadata to know the schema of a data block. This allows the system to correctly read the attributes specified in the filter and projection parameters.

A special HailRecord object is used as input value in the map function. This allows the user to directly read the projected attributes without splitting the value into attributes as he would do it in the standard Hadoop MapReduce. The new map function and the annotation are illustrated by the most-left white box in FIG. 3.

In step 302, the user submits the MapReduce job to the inventive system. For this purpose, a job client instance (‘JobClient’) is created on the client side. The main goal of the job client instance is to copy all the resources needed to run the MapReduce job (e.g. metadata and job class files). But also, the job client logically breaks the input into smaller pieces called input splits (split phase in FIG. 3) using the InputFormat-UDF. By default, the JobClient computes input splits such that each input split maps to a distinct HDFS block.

An input split defines the input data of a map task and a data block is a horizontal partition of a dataset stored in HDFS. For scheduling purposes the JobClient retrieves for each input split all data node locations having a replica of that block. This is done by calling the getHosts method. For instance in FIG. 3, block₄₂ is stored on data nodes DN3, DN5, and DN7, and hence these data nodes are the split locations for split₄₂.

After this split phase, the JobClient submits the job to the job tracker with a set of splits to process in step 303. Among other operations, the JobTracker creates a map task for each input split. Then, for each map task, the JobTracker decides on which computing node to schedule the map task, using the split locations in step 304. This decision is based on data-locality and availability, c.f. Dean et al. (“MapReduce: A Flexible Data Processing Tool. CACM, 53(1):72-77, 2010). After this, the Job-Tracker allocates the map task to the TaskTracker (which performs map and reduce tasks) running on that computing node in step 305. Only then, the map task can start processing its input split, which maps to a HDFS block (e.g., block₄₂). The map task uses a RecordReader UDF in order to read its input data block i from the closest data node in step 306.

The local HDFS client running on the node where the map task is running that decides from which data node a map task must read its input—and not the Hadoop MapReduce scheduler. This is done when the RecordReader asks for the input stream pointing to block i.

The HDFS client chooses a data node from the set of all data nodes storing a replica of block i (via the getHosts method) rather than from the locations given by the input split. This means that a map task might eventually end up reading its input data from a remote node. Once the input stream is opened, the RecordReader breaks block i into records and makes a call to the map function for each record. Assuming, for simplicity, that the MapReduce job is composed by a map phase only, the map task then writes its output back to HDFS in step 307.

Users may run MapReduce jobs exactly as in standard Hadoop MapReduce. However, supporting per-replica indexes in an efficient way and without significant changes in the standard execution pipeline is challenging for several reasons. First, the JobClient cannot simply create input splits based only on the default block size as each block replica has a different size (because of indexes). Second, the JobTracker can no longer schedule map tasks based on data-locality and nodes availability only. It now has to consider the existing indexes on each block replica. Third, the RecordReader has to perform either an index access or full scan of data blocks without any interaction with users. Finally, also the HDFS client cannot open an input stream to a given block anymore, based on data-locality and nodes availability only (it has to consider existing indexes as well).

The system and methods according to the invention overcome these issues by mainly providing a user-defined InputFormat and a user defined RecordReader. User defined functions (UDF) in Hadoop allow the invention to be easily integrated into standard Hadoop MapReduce framework.

The InputFormat in Hadoop selects the files or other objects that should be used for input, defines the InputSplits that break a file into tasks and provides a factory for RecordReader objects that read the file.

An InputSplit describes a unit of work that comprises a single map task in a MapReduce program. A MapReduce program applied to a data set, collectively referred to as a Job, is made up of several, possibly several hundred tasks. Map tasks may involve reading a whole file. By default, a file is broken up into 64 MB chunks, the same size as blocks in HDFS.

In contrast thereto, the system according to the invention uses a more elaborated splitting policy. One input split may correspond to several data blocks, if a MapReduce job performs an index access to read its input. This allows the inventive system to reduce the number of map tasks to process and hence to reduce the aggregated cost of initializing and finalizing map tasks.

However, each data block in any given input split might potentially be stored on a different data node. Using several data blocks as input split might decrease data locality. In order to avoid a significant increase in job runtimes, the system first clusters the blocks of the input of an incoming MapReduce job by locality. As a result, the system according to the invention produces as many collections of blocks as different data nodes storing at least one block of the given input. Then, for each collection of blocks, the system creates as many input splits as map slots a TaskTracker has.

After having computed the input splits according to the invention, the system according to the invention creates a map task per input split and schedules these map tasks to the replicas having the right index. For example in FIG. 3, DN5 has the right clustered index to execute split (i.e., mapTaskᵢ), hence the Job-Tracker schedules mapTaskᵢ to DN₅ (or closes to). If no relevant index exists, then the inventive system falls back to normal Hadoop and schedules each map task by optimizing data locality only. Restricting the scheduler to consider a single replica for scheduling map tasks (performing index access) does not significantly impact performance by reducing data-locality, for two reasons. First, using an adequate scheduler data-locality can be significantly improved. Second, fetching small parts of blocks through the network (which is the case when using index scan) is negligible.

The HailRecordReader is responsible for retrieving the records that satisfy the selection predicate of MapReduce jobs (white box inside the TaskTracker in FIG. 3). Those records are then passed to the map function. In order to find all records having, e.g. a visitDate between (1999-01-01, 2000-01-01), an input stream is opened to the block having the required index. For this, the system instructs the local HDFS Client to use the getHostsWithIndex method so as to choose the closest data node with the required index. Once the input stream has been opened, the information about selection predicates and attribute projections from the query annotation or from the job configuration file may be used. If the required index exists, the system performs a simple cost estimation of full scan versus index access.

When performing an index-scan, the index is read entirely into main memory (typically a few KB) to perform index lookup. This also implies reading the qualifying block parts from disk into main memory and applying post-filtering on them. Then, the projected attributes of qualifying tuples are reconstructed from PAX to row layout. In case that attributes projection is not specified by users, all attributes are reconstructed. Finally, the map function is called for each qualifying tuple.

If full scan is used, the selection predicate is still applied and tuple reconstruction performed.

All of this is implemented in the HailRecordReader. The post-filtering phase is skipped only if users do not specify any selection predicate.

According to a second embodiment of the invention, the waiting time of data-intensive jobs when accessing data from HDFS may also be decreased by internally organizing data blocks into column groups, based on a given workload. From the user perspective, the data analysis workflow remains the same: upload the input data and run the query workload exactly as before. Given a query workload W, at upload time, the layout is determined for each data block replica. Then, each data block replicas stored in its respective layout.

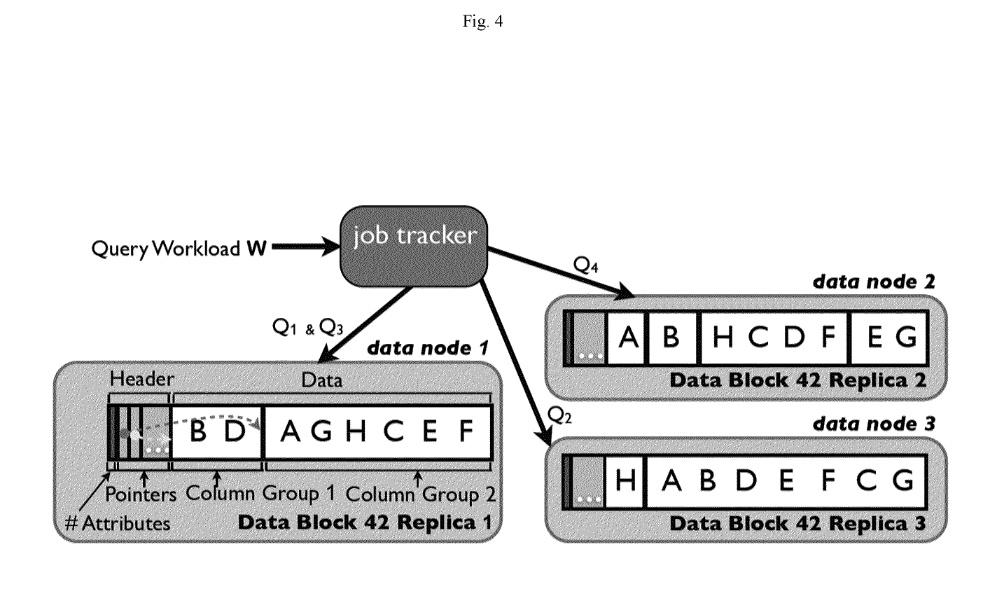

FIG. 4 shows an example of a per-replica layout according to a second embodiment of the invention.

A data block using a per-replica layout according to the invention is composed of header metadata and a set of column groups (see replica 1 in data node 1). The header contains the number of attributes stored in a data block and attribute pointers.

An attribute pointer points to the beginning of the column group that contains that attribute. For instance, in replica 1, the first attribute pointer (the red arrow) points to column group 2, which contains attribute A. The second attribute pointer would then point to column group 1, and so on. Each column group in turn contains a set of attributes in row-fashion, e.g. column group 1 in replica 1 has tuples containing attributes B and D.

At query time, an incoming MapReduce job is automatically adapted to query the data block replica that minimizes the data access time. Then, the map tasks or subqueries of the MapReduce job are routed to the data nodes storing such data block replicas. For example, in FIG. 4, the map tasks of Q4 are routed to data node 1, while the map tasks of Q1 and Q3 are routed to data node 2 and those of Q2 are routed to data node 3. In case the scheduler cannot route a map task to the best data block replica, e.g. because the data node storing such a replica is busy, the scheduler transparently fallbacks to other layouts. An important feature of the invention approach is that the Hadoop MapReduce interface is kept intact by providing the right itemize function in the Hadoop plan. As in normal MapReduce, users only care about map and reduce functions.

A column group is interesting if pairs of attributes in the column group are co-accessed in processing a given query, even though all attributes in the column group may not be co-accessed. In order to find the most suitable internal representation of data in data blocks, the invention focuses on two core operations: (i) determining the interesting column groups, and (ii) packing them within a data block such that the total interestingness of the data block is maximized. Denoting a set of complete and disjoint column groups as G₀, where G₀ is a subset of the set of all possible column groups, it will now be described how to find a complete and disjoint column group set G. that maximizes the total interestingness of a data block given a suitable function Intg(G) describing the interestingness of a particular group G.

Intuitively, a column group is highly interesting if it speeds up most or all of the queries in the workload. Thus, to formally define the interestingness of a column group, the access costs of queries in query workload W are taken into account. Let Path(Opt, Q) denote the access path chosen by optimizer Opt for query Q and let BA(Q, Path(Opt, Q)) denote the number of bytes of attribute A read by query Q when using access path Path(Opt, Q)1. The total bytes consumed by a query Q is denoted as its footprint FQ:

$${F}_{Q} = {\sum }_{A ∈ A} {B}_{A} ( Q , Path ( 0 pt , Q ) ) .$$

An attribute usage matrix U(Q, A) may be used to indicate whether or not an attribute A is referenced by query Q, i.e U(Q,A)=1, if Q references A, and 0 otherwise. However, U(Q, A) considers only the attribute occurrences, even though attribute non-occurrences give equally important information: they are crucial in determining whether one attribute should co-occur with another or not. To capture this, the invention generalizes U(Q, A) using a binary variable x, which denotes the occurrence (x=1) and the non-occurrence (x=0) of an attribute.

$${U}_{x} ( QA ) = \{ \begin{matrix}U {( Q , A}_{1 - U ( Q , A )} ) & {if x = 1 ,}_{if x = 0}\end{matrix} \}$$

The above usage matrix does not take into account the footprints (total byte access) of queries in which they occur. For instance, in the following example, attributes A, B, C have the same frequency in the workload.

| | Query footprint |
|---|---|
| Q₁ | 10 |
| Q₂ | 20 |
| Q₃ | 30 |
| Q₄ | 40 |

| | Q₁ | Q₂ | Q₃ | Q₄ |
|---|---|---|---|---|
| A | 1 | 1 | 0 | 0 |
| B | 0 | 0 | 1 | 1 |
| C | 0 | 1 | 0 | 1 |

However, attributes A,C are co-referenced by the cheaper query Q2 (i.e. having smaller footprint) whereas attributes B,C are co-referenced by more expensive query Q4 (i.e. having bigger footprint), thereby making B,C more likely to be together.

Therefore, a relative importance (RI) of attribute is needed, which takes query footprints into account. Intuitively, RIA is the fractional reading cost in the events when an attribute A occurs as well as when it does not. It may be as follows:

$${RI}_{A} ( x ) = \frac{{\sum }_{Q ∈ W} {F}_{Q} \cdot {U}_{x} ( Q , A )}{{\sum }_{Q ∈ W} {F}_{Q}} .$$

RIA is normalized by the total workload costs to make it comparable. Since one want to co-locate attributes inside data blocks, one need to determine whether two attributes should be stored together. Thus, RI_{A,B}(x, y) may be defined as the relative importance of an attribute pair A, B in terms of the query workload cost.

$${RI}_{A , B} ( x , y ) = \frac{{\sum }_{Q ∈ W} {F}_{Q} \cdot {U}_{x} ( Q , A ) \cdot {U}_{y} ( Q , B )}{{\sum }_{Q ∈ W} {F}_{Q}} .$$

Now, to estimate the similarity between two attributes A and B over the range of values of x and y, their mutual dependence may be measured using the mutual informationbetween them. The mutual information between two attributes may be computed using their relative importances as follows:

$$MI ( A , B ) = {\sum }_{x ∈ \{ 0 , 1 \}} {\sum }_{y ∈ \{ 0 , 1 \}} {RI}_{A , B} ( x , y ) \cdot log ( \frac{{RI}_{A , B} ( x , y )}{{RI}_{A} ( x ) \cdot {RI}_{B} ( y )} ) .$$

Essentially, MI(A, B) measures the information (data access patterns) that attributes A and B share. MI(A, B) is normalized by the minimum entropies of the two attributes to normalize its range MI(A;B) between 0 and 1, i.e.

$$nMI ( A , B ) = \frac{MI ( A , B )}{min ( H ( A ) , H ( B ) )} .$$

Here, H(A) and H(B) denote the entropy of attributes A and B. For an attribute A, its entropy is computed as:

$$H ( A ) = {\sum }_{x ∈ \{ 0 , 1 \}} {RI}_{A} ( x ) \cdot log ( \frac{1}{{RI}_{A} ( x )} ) .$$

Finally, column group interestingness may be defined as the average normalized mutual information of any given attribute pair in G.

$$Intg ( G ) = \{ \begin{matrix}\frac{1}{( \begin{matrix}\vert G \vert \\ 2\end{matrix} )} \cdot {\sum }_{\{ A , B \} ∈ G , A \neq B} nMI ( A , B ) & \vert G \vert > 1 , \\ \frac{1}{\vert A \vert - 1} \cdot {\sum }_{A ∈ G , B ∈ A \backslash G} 1 - nMI ( A , B ) & \vert G \vert = 1.\end{matrix}$$

For column groups having a single attribute, the inverse of the mutual information with any other attribute in A is taken. In other words, the benefit of the attribute in the column group not occurring with any other attribute in A is measured. Intg(G) has values between 0 and 1. Higher interestingness indicates higher mutual dependence within a column group.

By default, one would have to consider all column groups (O(2|A|)) within a data block. In order to reduce the search space, the threshold interestingness value may be determined experimentally and all column groups having interestingness below that threshold can be discarded. A higher interestingness threshold produces a smaller set of candidate column groups. This has two consequences: (i) the search space for finding the best combination of column groups becomes smaller, and (ii) only the attributes appearing in highly interesting column groups remain in the candidate set and are thus likely to be grouped. All remaining attributes which do not appear in any of the highly interesting column groups will end up in row layout. Apart from threshold based pruning, further aggressive pruning may be performed, for column groups having same interestingness value, in two ways: (i) keep the smallest column group to reduce redundant data read, or (ii) keep the largest column group to reduce tuple reconstruction costs.

Once the candidate column groups along with their interestingness values have been obtained, these column groups are packed into a data block such that the total interestingness of all column groups in the data block is maximized. This is an NP-hard problem. It may be mapped it to a 0-1 knapsack problem, with an extra disjointness constraint, to solve it.

For a given column group G, let id(G) denote the group identifier (a numeric in binary representation) such that its ith bit is set to 1 if G contains attribute i, it is set to 0 otherwise. Given m column groups, one has to find 0-1 variables x1, x2, . . . , xm—where xi is 1 if column group Gi is selected and 0 otherwise—such that the total interestingness is maximized. Additionally, the sum of the group identifiers should be at most id(A) and each of the groups should be disjoint. Formally, maximize

Σᵢ₌₁^{m}Intg(Gᵢ)·xᵢ

subject to the constraints:

$$\begin{matrix}{\sum }_{i = 1}^{m} id ( {G}_{i} ) \cdot {x}_{i} \leq id ( A ) & ( 1 ) \\ {x}_{i} + {x}_{j} \leq 1 , ∀ i , j s . t . i \neq j ⋀ {G}_{i} ⋂ {G}_{j} \neq ∅ . & ( 2 )\end{matrix}$$

Here, (2) is an extra constraint to the standard 0-1 knapsack problem. Constraint (2) allows to pre-filter non-disjoint column groups. Therefore, a branch and bound technique may be applied. The idea is to consider a column group and its subsequent combinations with other column groups, only if it is disjoint with the column groups currently in the knapsack.

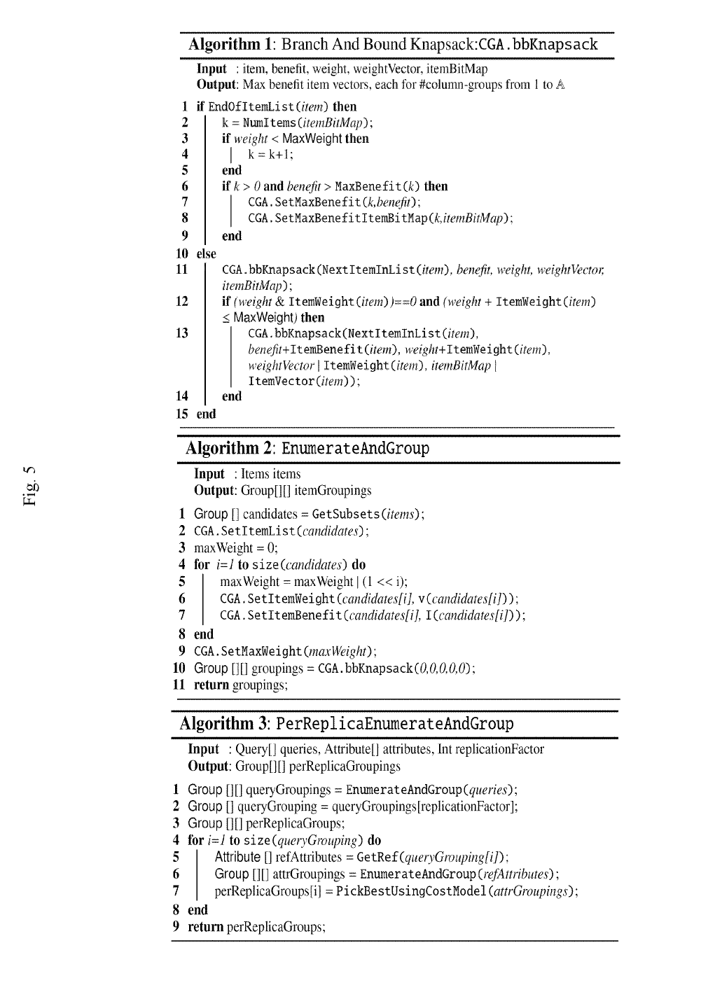

FIG. 5, algorithm 1 shows the pseudo-code of this technique.

The algorithm denotes a column group as a knapsack item, its interestingness as the benefit, and its group identifier as weight. In case all knapsack items have been explored, it is checked if a knapsack was obtained with greater benefit than before (lines 1 to 10). Else, CG.bbKnapsack is called recursively in two cases: (i) without taking the current item into the knapsack (line 12), and (ii) taking the current item if it satisfies constraints (1) and (2) (lines 13 to 15).

The interestingness function of the invention does not consider the size of the column group. However, for operators such as joins, the number and sizes of column groups would be quite important. Thus, the above problem is solved each for the number of column groups ranging from 1 to |A|, as shown in FIG. 5, algorithm 2. First, the column groups are generated (line 1) and added to the item list (line 2), then the weight (group identifier) and benefit (interestingness) of each item are set (lines 4 to 8). The parameter maxWeight is set to the maximum item weight and CG.bbKnapsack is called, which returns a column group set each for the number of groups ranging from 1 to |A|. As the number of solutions is equal to the number of attributes in the relation, it is now feasible to compare and pick the best partitioning using a cost model.

The inventive column grouping algorithm, along with column group pruning, works well for several realistic datasets, e.g. for TPC-H tables (having a maximum of 16 attributes) and for SSB tables (having a maximum of 17 attributes). However, finding the right layouts for scientific data sets (having hundreds of attributes), like SDSS, becomes a difficult task to achieve. Luckily, HDFS replicates data blocks three times by default to ensure the availability of data blocks. Thus, instead of using the same data layout for all the three replicas, the invention creates a different layout per replica. This divide-and-conquer approach significantly reduces the complexity of the column grouping algorithm.

The core idea of per-replica layout is to first create query groups (using the same column grouping algorithm) and then create column groups for each query group separately. This serves two purposes: (i) instead of creating a single layout for the entire workload, multiple layouts are created, each specialized for a part of the workload, and (ii) query grouping can significantly decrease the number of referenced attributes for each query group, which, in turn, reduces the complexity of the column grouping algorithm according to the invention.

FIG. 5, algorithm 3 shows the pseudo-code to compute per-replica layouts in two steps:

(1.) Query Grouping. First, queries in the workload are grouped based on their access pattern. Column grouping is orthogonal to query grouping. However, two queries are similar if they access similar attributes just as two attributes are similar if they are accessed by similar queries. In that respect, query grouping, or rather partitioning, is very similar to column grouping. Therefore, the inventive column grouping algorithm (algorithm 2 in FIG. 5) may be used for query grouping as well, by just interchanging attributes and queries (line 1).

As a result of running algorithm 2 for query grouping, a collection of query group sets is obtained that are complete and disjoint. Each query group set in the collection contains a different number of query groups. The query group set having as many query groups as the replication factor is picked in line 2, thus mapping one query group to one data block replica. However, one may as well map one query group to multiple replicas, depending on the workload.

In order to deal with the complexity of query grouping for large workloads, query grouping may be applied recursively: (i) first, consecutive sets of p queries are (independently) grouped, (ii) then the queries in a query group are XORed in order to represent each query group as a single combined query, (iii) now consecutive sets of p combined queries are again grouped (independently), and (iv) this process is repeated until a single set of p or less queries is obtained. Here p denotes the maximum number of queries which can be grouped in reasonable time. Experimentally, p may be determined to be less than or equal to 20.

(2.) Query Routing. Finally, for each query group, the referenced attributes are obtained and column groups are built on them in lines 5 to 6 in algorithm 2. The best column grouping is picked among groupings of different size using a cost model in line 7.

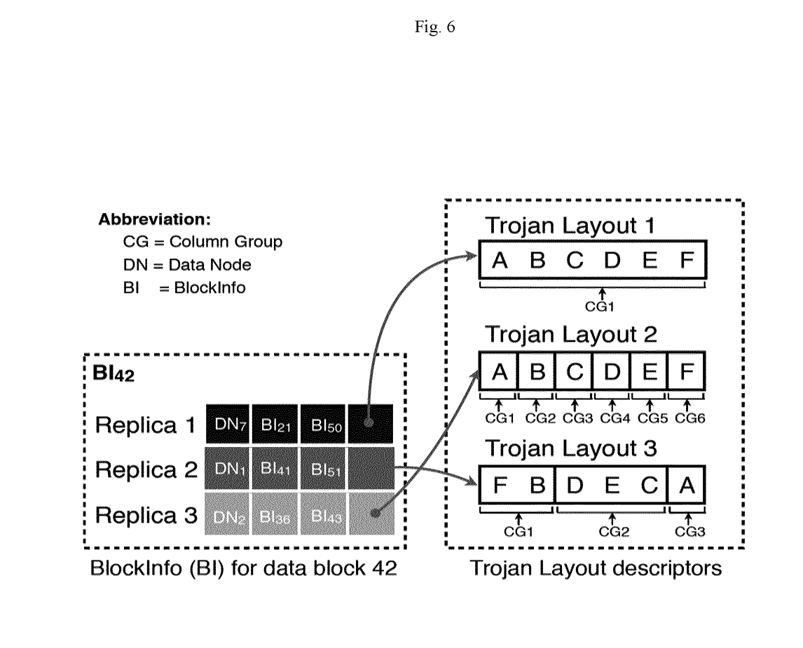

FIG. 6 shows quadruplets for a data block stored at a name node according to the second embodiment of the invention.

The invention may be implemented as a variant of HDFS in order to introduce per-replica layouts into HDFS. The inventive data storage system differs from HDFS in two aspects:

First, the name node keeps a catalog of the different layouts of all data block replicas. The system exploits the fact that the name node maintains a triplet of pointers for each data block replica. It adds a fourth pointer to this structure, which points to the layout descriptor of the data block replica. More than one data block replica could point to the same layout descriptor.

Second, a data node in the inventive data storage system asks the name node for the layout of each data block replica stored locally. After receiving the layout for a given data block replica, a data node internally reorganizes the data of the data block replica according to the received layout. There are two ways, for a data node, to do so: (i) reorganize a data block as soon as the data block replica is copied locally, or (ii) reorganize a data block after all replicas of the data block are copied to relevant data nodes. Although, data nodes do not have to wait for other replicas to be copied in, the first strategy generates contention between data nodes for accessing data block replicas, because a data node would be accessing a given local data block replica for transformation while another data node would be trying to remotely copy the same data block replica for replication. This contention will, in turn, significantly increase the data upload time. Therefore, in the invention, the second strategy is applied, i.e. data nodes start data block reorganizations after all replicas are copied. An example of the resulting internal organization of a data block was shown in FIG. 4.

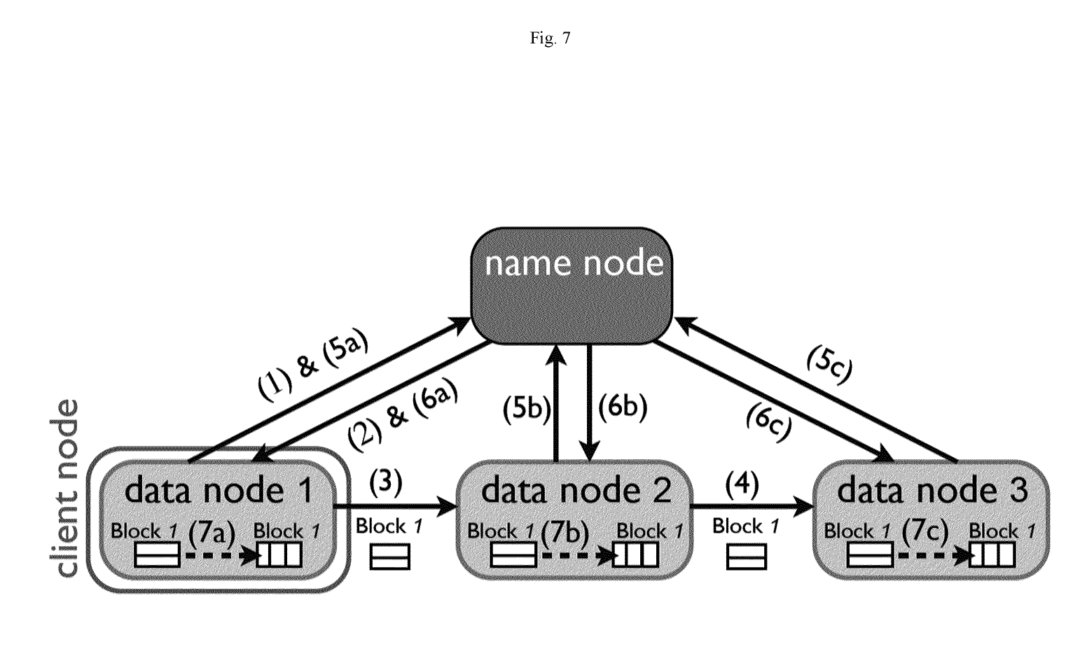

FIG. 7 depicts the upload process with a replication factor of three (3).

For simplicity, it is assumed that the data set to upload contains only a single data block. The idea is that as soon as all replicas of a data block are copied, the data nodes internally reorganize replicas according to their assigned layout.

In step 1, the client node (e.g. data node 1) asks the name node to register a data block (e.g. data block 1). In step 2, the name node returns the set of data nodes to hold the three data block replicas (e.g. data nodes 1, 2, and 3). In step 3, after storing data block 1 locally, data node 1 sends a replica to data node 2; (4) data node 2 stores data block 1 locally and sends a replica to data node 3, which in turn also stores data block 1 locally. In steps 5a to 5c, each data node then informs the name node of the newly received data block 1. In steps 6a to 6c, the name node returns the layout corresponding to the data block replica stored by each data node. In steps 7a to 7c, finally, each data node transforms data block 1 into its respective layout. In case a user uploads a data set that is not in the layout configuration file, the name node asks the data nodes to keep the data layout unchanged (typically row layout).

To process an incoming MapReduce job, first the attributes which need to be read are identified. Then, a cost model is used to automatically pick the best layout in the invention data storage system for the MapReduce job. Then, map tasks are scheduled to those data nodes storing data block replicas in the best layout (given by the cost model). An itemize UDF may be provided to the map tasks so that they can read only the referenced attributes and reconstruct tuples, all invisible to the users.

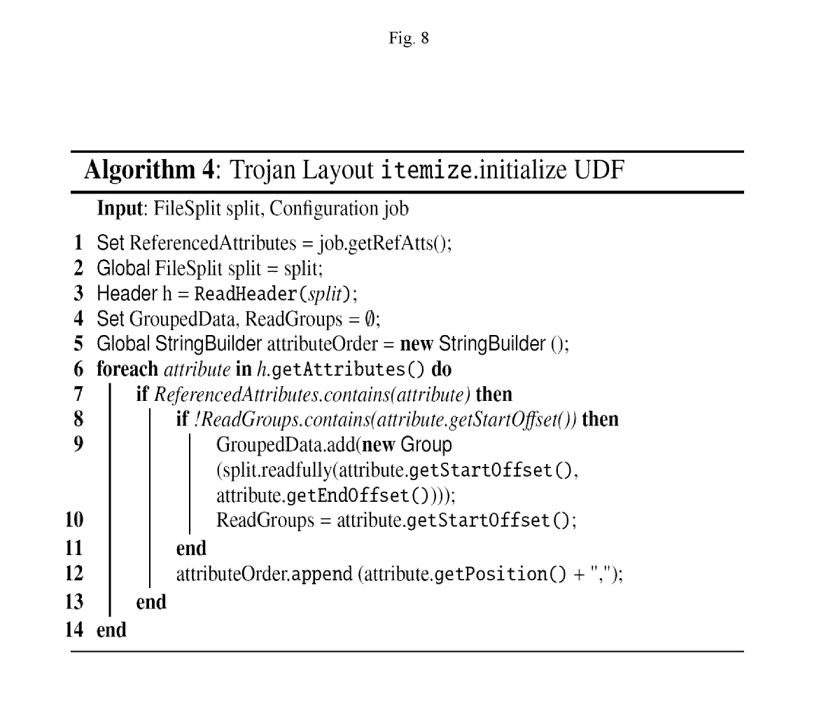

FIG. 8 shows—in pseudo code—an algorithm for enabling a map task or subquery to transparently read referenced attributes from data blocks and automatically reconstruct tuples as expected by applications (MapReduce jobs).

In line 1, the required attributes are obtained from the job configuration. Then, in lines 2 and 3 the header of a data block is read. The header information indicates the column groups that contain the referenced attributes (relevant column groups). Such relevant column groups are uploaded into main memory in lines 6 to 10. Additionally, the position of each referenced attribute is tracked in line 12, in order to allow a map function to know how attributes are ordered in a tuple. Now, to feed tuples to the map function, the method iterates over each column group and checks if a column group has more tuples. If so, the tuple is reconstructed from relevant column groups and passed to the map function. Otherwise, the end of tuples is signaled.

By default, the Hadoop MapReduce scheduler tries to allocate map tasks to those data nodes having any replicas of the requested data block locally. However, with per-replica layouts according to the invention, scheduling map tasks to data nodes having different data block replicas may have quite different performance. For example, a MapReduce job requiring one attribute out of 16 can be completed faster if the input data set is in column-layout. Therefore, to query per-replica layouts according to the invention, map tasks are always scheduled to those nodes storing the best layout (best-layout policy, for short). This policy is reasonable because, if map tasks are slightly delayed, only 1% of map tasks need to fetch the best layout in practice. Still, in case of contention, the best-layout scheduling policy may delay several map tasks.

To avoid this delay, one may either: (i) schedule map tasks to available nodes even if they do not store the best layout; later, map tasks fetch data blocks with the best layout (Fetch Best-Layout policy), or (ii) schedule map tasks to those nodes storing the second best layout; later, map tasks read the local data blocks (2nd best-layout policy). Both fetch best-layout and 2nd best-layout scheduling policies avoid delaying map tasks. However, fetch best-layout policy now incurs networks costs to fetch the best layout whereas the second best-layout policy affects the data access performance.

According to a third embodiment of the invention, the above-described independent modifications of the Hadoop MapReduce system may be combined.

The above-described generation of different layouts per replica according to the invention overcomes the first problem. However, it is limited to vertical partitioning, i.e. it only considers whether or not an attribute is referenced (scan, projections) by a query—a binary decision. More particularly, the layout algorithm according to the invention, like most other column grouping algorithms, starts with a 0-1 usage matrix, each cell denoting whether or not an attribute is referenced by a query.

Now, according to the third embodiment of the invention, the usage matrix may be modified as follows: Each cell of the usage matrix now contains the attribute range over which a given query accesses the corresponding attribute, i.e. the usage matrix not only tells whether an attribute is accessed or not, but also the range in which the attribute is accessed.

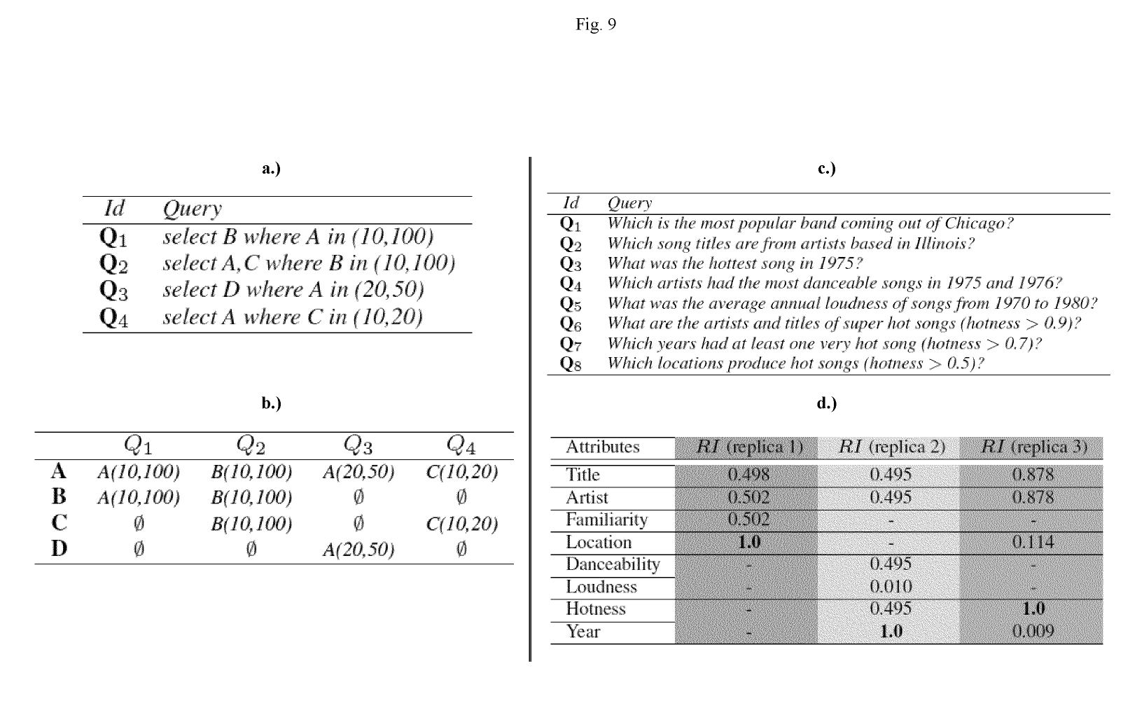

FIGS. 9a and 9b show examples of a query set and a usage matrix determined according to this modified approach.

In the usage matrix, the usage function U(Q,A) is a set of values, if query Q references attribute A, and an empty set otherwise.

For instance, U(Q1,A)=U(Q1,B)=A(10,100), indicating that the two attributes (A and B) are accessed in range (10,100) of A. Using this new usage matrix in the inventive layout algorithm, query groups and column groups may now be computed, taking both selections and projections into account.

The first step for index selection according to the invention is query grouping, considering both selection and projection predicates, as described above. Thereafter, for each replica, the following may be done: First, the attributes are ranked by their relative importances (RI). Let FQ denote the number of bytes accessed (footprint) by query Q in workload W. The relative importance (RIA) of attribute A gives the byte footprints of queries relevant for attribute A. In contrast to the layouts according to the invention, the relative importances also take into account the fraction of column A accessed by each query:

$${RI}_{A} = \frac{{\sum }_{Q ∈ W} {F}_{Q} \cdot \frac{\vert U ( Q , A ) \vert}{\vert A \vert}}{{\sum }_{Q ∈ W} {F}_{Q}}$$

Finally, a clustered index is created on attributes having the maximum importance. Optionally, one could also create unclustered indexes for the remaining attributes.

FIGS. 9c and 9d show examples of another query set and usage matrix.

In the first step, the automatic index selection method according to the invention creates three query groups (Q1, Q2), (Q3,Q4,Q5), (Q6,Q7,Q8), one for each replica in HDFS. Indeed, queries Q1 and Q2, for instance, have similar selection predicates and hence it makes sense to group them together. Then, for each replica, the relative importances of the attributes may be computed, i.e. RIA.

In the table shown in FIG. 9c, attributes Location, Hotness, and Year have relative importance of 1.0 in the three replicas. This suggests creating clustered indexes on these three attributes.

An embodiment of the replicated data storage system according to the invention has been implemented on four different clusters. The first was a physical 10-node cluster. Each node had one 2.66 GHz Quad Core Xeon processor running 64-bit platform Linux openSuse 11.1 OS, 4×4 GB of main memory, 6×750 GB SATA hard disks, and three Gigabit network cards. A physical cluster has the advantage that the amount of runtime variance is limited. Yet, to fully understand the scalability of the present invention, the inventors also used four different virtual clusters based on EC2. Clusters two to three have ten nodes each. For each cluster, different node instance types were used. Finally, for the fourth cluster, the number of nodes was scaled up to 100 nodes.

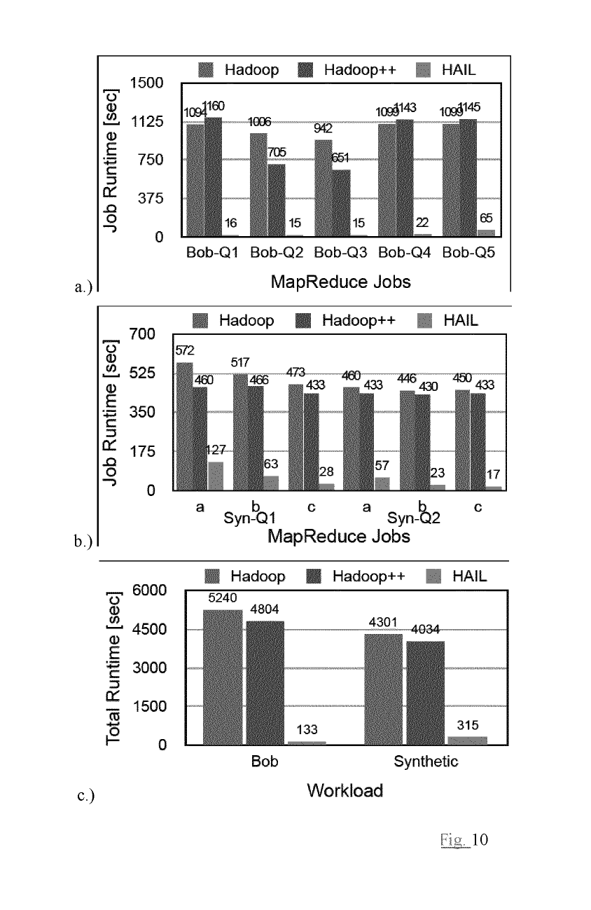

FIG. 10 shows diagrams a, b and c with data on the performance of the inventive system as compared to the standard Hadoop MapReduce and the Hadoop++ system.

Two different datasets were used for the benchmark. First, the UserVisits table as described by Pavlo et al. (“A Comparison of Approaches to Large-Scale Data Analysis”. Sigmod 2009) was used. This dataset nicely matches Bob's Use Case. 20 GB of UserVisits data per node were generated using the data generator proposed by Pavlo et al.

Second, a synthetic dataset consisting of 19 integer attributes was used in order to understand the effects of selectivity. The synthetic dataset is similar to scientific datasets, where all or most of the attributes are integer/float attributes (e.g., the SDSS dataset). For this dataset, the inventors generated 13 GB per node.

For the UserVisits dataset, the workload comprises the following queries:

Bob-Q1 (selectivity: 3.1×10−2)
SELECT sourceIP FROM UserVisits WHERE visitDate
BETWEEN ‘1999-01-01’ AND ‘2000-01-01’

Bob-Q2 (selectivity: 3.2×10−8)
SELECT searchWord, duration, adRevenue
FROM UserVisits WHERE sourceIP=′172.101.11.46′

Bob-Q3 (selectivity: 6×10−9)
SELECT searchWord, duration, adRevenue
FROM UserVisits WHERE sourceIP=′172.101.11.46′ AND visitDate=′1992-12-22′

Bob-Q4 (selectivity: 1.7×10−2)
SELECT searchWord, duration, adRevenue
FROM UserVisits WHERE adRevenue>=1 AND adRevenue<=10

Additionally, a variation of query Bob-Q4 is used to see how well the inventive system performs on queries with low selectivities:

Bob-Q5 (selectivity: 2.04×10−1)
SELECT searchWord, duration, adRevenue
FROM UserVisits WHERE adRevenue>=1 AND adRevenue<=100

For the synthetic dataset, the synthetic queries are shown in the following table:

| Query | #Projected Attributes | Selectivity |
|---|---|---|
| Syn-Q1a | 19 | 0.1 |
| Syn-Q1b | 9 | 0.1 |
| Syn-Q1c | 1 | 0.1 |
| Syn-Q2a | 19 | 0.01 |
| Syn-Q2b | 9 | 0.01 |
| Syn-Q2c | 1 | 0.01 |

All synthetic queries use the same attribute for filtering. Hence for this dataset the inventive system cannot benefit from its different indexes: it creates three different indexes, yet only one of them will be used by these queries. A third set of queries was also run with a selectivity of 0.0001, but the results were quite similar to Syn-Q2a-SynQ2c.

FIG. 10a shows the end-to-end runtimes for Bob's queries. The inventive system (designated by the name ‘HAIL’ in the diagram) outperforms both Hadoop and Hadoop++ in all queries (by an improvement factor of 1.6 on average). For Bob-Q2 and Bob-Q3, Hadoop++ has similar results as the inventive system since both systems have an index on sourceIP. However, the inventive system still outperforms Hadoop++. This is because it does not have to read any block header to compute input splits while Hadoop++ does. Consequently, it can start processing the input dataset earlier than Hadoop++ and hence it finishes before.

FIG. 10b shows the end-to-end job runtimes for the synthetic queries. Again, the inventive system outperforms both Hadoop and Hadoop++. Even if Hadoop++ has an index on the selected attribute, Hadoop++ runs slower than the inventive system, because the inventive system splits the input faster than Hadoop++.

FIG. 10c shows a comparison between Bob's and the synthetic workload.

1. A method for storing data, comprising the steps:
partitioning the data into data blocks; and
storing multiple replicas of a data block in a machine readable medium.

2. The method according to claim 1,
wherein the multiple replicas of a data block comprise different layouts.

3. The method according to claim 1,
wherein the replicas of each data block comprise different sort orders.

4. The method according to claim 1, wherein the replicas of a data block are stored together with different indexes.

5. The method according to claim 4, wherein the indexes are clustered.

6. The method according to claim 4,
wherein the indexes are created while uploading the data to a system for managing it.

7. The method according to claim 2, wherein the different layouts are created, based on a workload of the data management system.

8. The method according to claim 7, wherein each of the different layouts comprises a different ordering of attributes.

9. The method according to claim 7, wherein the data management system is a map-reduce-system.

10. The method according the claim 7, wherein the attributes are grouped also based on an attribute usage of the query in the workload.

11. The method according to claim 10, wherein the attributes are grouped based a relative importance of attribute pairs in terms of the query workload cost.

12. The method according to claim 11, wherein the attributes are grouped based on a mutual information between attributes.

13. The method according to claim 12, wherein the mutual information must be larger than an experimentally determined threshold.

14. The method according to claim 13, wherein the attributes re grouped by solving a 0-1-Knapsack problem.

15. Method according to claim 4, wherein attributes for which indexes are created are selected automatically.

16. The method according to claim 15, wherein a user may choose whether to create just the column groups, or just the indexes, or both.

17. A method for executing a query to a database, wherein the database is partitioned into data blocks, wherein a data block is stored in different replicas, comprising the steps:
receiving the query;
selecting a data block replica, based on the query;
routing subqueries to a data node storing the selected data block replica and the physical layout.

18. The method according to claim 17, wherein the selected data block replica has minimal access or second best access time.

19. The method according to claim 17, wherein a subquery processes several data blocks of the data node, if the query performs an index scan.

20. The method according to claim 17, wherein a subquery processes a single data block of the data node, if the query performs a full scan.

21. A system for storing data, comprising:
means for partitioning a mechanism constructed and adapted to partition the data into data blocks;
data nodes constructed and adapted to store for storing multiple replicas of each data block in a machine readable medium; and
a name node, wherein the name node maintains a pointer to a layout descriptor of a data block replica.
